(19) United States
(12) Patent Application Publication
(10) Pub. No.: US 2016/0314544 A1
(43) Pub. Date: Oct. 27, 2016

(54) METHOD OF PROVIDING ELECTRIC POWER TO A HOST

(71) Applicant: Scuderi Group, Inc., West Springfield, MA (US)

(72) Inventors: Nicholas Scuderi, Agawam, MA (US); Salvatore Scuderi, Westfield, MA (US); Matthew Austin Fioretti, East Longmeadow, MA (US); Stephen Peter Scuderi, Westfield, MA (US)

(73) Assignee: Scuderi Group, Inc., West Springfield, MA (US)

(21) Appl. No.: 15/138,543

(22) Filed: Apr. 26, 2016

Related U.S. Application Data
(60) Provisional application No. 62/152,996, filed on Apr. 27, 2015.

(51) Int. Cl. G06Q 50/06; G06Q 40/04

(52) U.S. Cl. CPC G06Q 50/06; G06Q 40/04

(57) ABSTRACT

A method of providing electric power and energy to a host comprises executing a power purchase agreement between a provider and the host. The provider has an electric generator system and the host has a facility located on a property of the host. The provider becomes a market participant in the regional wholesale electricity markets. The provider installs the generator system on the host's property. The provider provides power and energy to the host's facility through a local utility as an electric supplier. The provider provides distributed power and energy to the host's facility directly from the generator system.

### CROSS-REFERENCE TO RELATED APPLICATIONS

This application claims priority to U.S. Provisional Patent Application No. 62/152,996, filed on Apr. 27, 2015, which is hereby incorporated by reference in its entirety.

### FIELD

The present invention relates to systems, methods and business methods of providing electric power and energy to an end user. More specifically, the invention relates to a provider installing a system for generating electric power on the property of a host. The system provides electric power to the host transmitted through a local utility as the host's electric supplier. The system also provides distributed power directly to the host without being transmitted through the local utility to peak shave the amount of energy purchased from the local utility.

### GLOSSARY

For purposes of clarity the following words and phrases shall be defined herein as follows:

“Congestion” means a shortage of electric energy transmission capacity to a waiting market of users. Attempting to operate a transmission system beyond its rated capacity (i.e., when the transmission system is congested) is likely to result in line faults and electrical fires and, therefore, must be avoided. Generally, as congestion increases for transmitting a given amount of electric energy, the cost of purchasing such energy for a user at the receiving area will also increase.

“Distributed Power” or “Distributed Power Generation” is the process of generating power and energy on-site at the point of consumption. Distributed power is supplied directly to an end user, such as a host, without being transmitted through a local utility. A provider which provides solely distributed power generation is not a market participant in the wholesale electricity markets and does not have to execute a generator interconnection agreement with a utility.

“Electric Supplier” means a company or other entity or person that has governmental approval from a governmental authority to provide electric generation services through the grid to end use customers using the transmission and/or transmission facilities of a local utility. Electric suppliers must be qualified as a market participant in the wholesale electricity markets in order to transmit energy and power through the grid. Electric suppliers generally transmit electric energy over the grid and sell that electric energy to various local utilities at wholesale rates. The local utilities will then typically distribute that energy to various end users at retail rates.

“Grid (also referred to an electrical grid, electric grid or electricity grid)” means an interconnected network for delivering electricity from electric suppliers to electric consumers. It typically includes generating stations that produce electrical power and energy, high-voltage transmission lines that carry power and energy from distant sources to demand centers, and distribution lines of utilities that connect individual customers (or consumers). A grid is generally a bulk electric power and transmission line system, which usually services a particular geographic area, such as New England.

“Governmental Approval” means any approval, consent, franchise, permit, certificate, resolution, concession, license, or authorization issued by or on behalf of any applicable governmental authority.

“Governmental Authority” means any federal, state, regional, county, town, city, or municipal government, whether domestic or foreign, or any department, agency, bureau, or other administrative, regulatory or judicial body of any such government.

“Host” is a person or entity having an ownership interest or leasehold interest in a property upon which a provider of electric power and energy installs a system for generating electric power and energy to the host.

“Independent System Operator” (ISO) means an organization formed at the direction or recommendation of the Federal Energy Regulatory Commission (FERC). In the areas where an ISO is established, it coordinates, controls and monitors the operation of the electric power system (or grid), usually within a single US state, but sometimes encompassing multiple states. An ISO typically operates a region's electricity grid, administers the region's wholesale electricity markets, and provides reliability planning for the region's bulk electricity system.

“Interconnection Agreement” or “Generator Interconnection Agreement” is a written agreement between a provider and a utility which details the qualifications, responsibilities and obligations required to connect the provider's electric generator system to the utility's grid distribution facilities.

“ISO New England” is the ISO responsible for the New England states. ISO New England began operation as an RTO in 2005, assuming broader authority over day-to-day operation of New England's transmission system and greater independence to manage New England's electric power system and competitive wholesale electricity markets.

“Load” or “Electric Load” is an electrical component, system of electrical components or portion of a circuit that consumes electric power and energy.

“Losses” mean electrical losses due to resistance and impedance of the lines and equipment required to transmit electric power and energy through a grid. Generally, as the losses increase for transmitting a given amount of electric energy, the cost of purchasing such energy for a user at the receiving area will also increase.

“Market Participant” means a person or entity that participates in the wholesale electricity markets. A market participant must have successfully completed a membership process with the administrator of the regional wholesale electricity markets, such as an ISO, RTO or similar, and have signed an agreement with the administrator, typically known as a market participant service agreement, which details the qualifications, responsibilities and obligations required for participating in the wholesale electricity markets. By way of example, one such typical obligation of a market participant is to agree to adhere to a financial assurance policy set by the administrator, which ensures that all market participants are in a good financial position and will not cause undue risk to the wholesale electricity markets.

“Peak Shaving” or “Peak Shave” is the process of reducing the amount of energy purchased, and therefore the amount of costs incurred, from the local utility. Peak shaving is typically done during peak hours when the charges from the utility are highest.

“Person” means an individual, partnership, corporation, limited liability company, business trust, joint stock company, trust, unincorporated association, joint venture, firm, or other entity, or a governmental authority.

“Power Purchase Agreement” or “PPA” means an agreement whereby a provider of electric power and energy agrees to sell, and a user of electric power and energy agrees to buy, electric power and/or energy for a certain period of time.

“Provider” is a person or entity having and controlling an electric generator system for generating electric power and energy to end users.

“Regional Transmission Organization” or “RTO” in the United States is an organization created by the FERC that is responsible for moving electricity over large interstate areas. An RTO performs the same functions as an ISO, including administering the regional wholesale electricity markets, but generally over larger regions and with an added component of greater responsibility for the transmission network of the grid as established by the FERC.

“Retail Electricity Market” is a market wherein end-user customers (or consumers) of electricity can choose from competing electricity retail suppliers.

“Split-Cycle Engine” is an engine having a crankshaft rotatable about a crankshaft axis and also having a compression piston slidably received within a compression cylinder and operatively connected to the crankshaft such that the compression piston reciprocates through an intake stroke and a compression stroke during a single rotation of the crankshaft. The split-cycle engine additionally includes an expansion (power) piston slidably received within an expansion cylinder and operatively connected to the crankshaft such that the expansion piston reciprocates through an expansion stroke and an exhaust stroke during a single rotation of the crankshaft. Additionally, the split-cycle engine includes a crossover passage interconnecting the compression and expansion cylinders. The crossover passage including at least a crossover expansion (XovrE) valve disposed therein, but more preferably including a crossover compression (XovrC) valve and a crossover expansion (XovrE) valve defining a pressure chamber therebetween. Several types of split-cycle engine technologies are described in U.S. Pat. No. 6,952,923 filed on Jun. 9, 2004, U.S. Pat. No. 8,677,953 filed on Mar. 14, 2011, U.S. patent application Ser. No. 14/543,223 filed on Nov. 17, 2014 and U.S. provisional patent No. 62/120,770 filed on Feb. 25, 2015, all of which are herein incorporated by reference in their entirety.

“Split-Cycle Engine Expander” or “Split-Cycle Expander” is essentially a stand-alone version of the expansion (or combustion) portion of a split-cycle engine. That is, a split-cycle expander includes an expansion cylinder having an expansion piston reciprocally disposed therein. A connecting rod typically couples the expansion piston to a crankshaft. The top of the expansion cylinder is closed by a cylinder head having an intake valve and an exhaust valve disposed therein, usually along with a fuel injector and an ignition device, such as a spark plug. (In embodiments in which diesel fuel is used, the ignition device can be omitted and compression ignition can be used to initiate combustion.) The intake valve controls fluid communication between a source of compressed air (such as, an air storage tank or a separate compressor) and the expansion cylinder. The exhaust valve controls fluid communication between the expansion cylinder and an exhaust passage. Split-cycle expander technologies are described in U.S. patent application Ser. No. 14/543,223 filed on Nov. 17, 2014 and U.S. provisional patent No. 62/120,770 filed on Feb. 25, 2015, both of which are herein incorporated by reference in their entirety.

“User” or “End User” is a person or entity that uses or consumes electric power and energy. Typically an end user is a retail customer of a local utility which transmits power and energy to that user through the local distribution facilities of the grid.

“Utility” or “Local Utility” means the local electric distribution company that provides electric transmission and distribution services to end users. A utility typically controls the local distribution facilities of the grid and transmits electric power and energy from electric suppliers to end users through those local distribution facilities.

“Wholesale Electricity Market” means a market through which electric energy, capacity resources and/or other electrical resources are transmitted, bought and/or sold for ultimate distribution to the public. Typically wholesale electricity markets are designed and administered by an Independent System Operator (ISO), such as ISO-New England, which is authorized by the Federal Energy Regulatory Commission (FERC) to oversee the operation of New England's bulk electric power and transmission line system, i.e., New England's electrical grid.

### BACKGROUND

Users (or end users) that consume electric energy, such as schools, universities, hospitals, farms, municipalities, distributorships, supermarkets, factories, office buildings and many more, generally obtain such energy either through a local utility, or from an on-site generator which supplies distributed power to the user. Most typically, energy is delivered to an end user from a large (20 megawatts or greater), remotely located electric supplier which is a market participant in the wholesale electricity markets. As a market participant, the electric supplier generates and transmits power and energy to multiple users through a local utility. Alternatively, distributed power, which is power and energy generated on-site at the point of consumption and delivered directly to an end user without going through a local utility and without being a market participant, is growing in popularity as a method and system for reducing at least a portion of a user's electric energy costs.

However, both systems for delivering power and energy to an end user have their problems. In the case of a remotely located electric supplier, an end user must pay costs incurred by the electric supplier for producing the energy and costs incurred by both the electric supplier and the local utility for transmitting the energy to the end user. Costs incurred for transmitting energy are affected by such factors as congestion and losses in the transmission system (grid) from the electric supplier to the local utility and from the local utility to the end user. The more remote an electric supplier is from an end user, the greater the potential for such congestion and loss to increase the cost of transmission.

Additionally, congestion can also be affected by geographic obstacles such as islands or mountains which necessarily limit the amount of transmission lines that are available to transmit energy to an end user. A good example of this would be the island of Long Island, New York, USA, which has a large demand for electric energy because it is highly industrialized but has limited transmission line capacity for such demand due, at least in part, to the fact that it is an island. Therefore, a generator system located on Long Island will experience substantially less congestion in transmitting energy to users throughout Long Island than that same generator system would if it was to be located a few miles away on the USA mainland.

Moreover, power delivered through a local utility will also be subject to demand charges that will increase as the peak power consumption of an end user increases. That is, a utility company will generally charge a user a substantial demand fee if its peak power consumption exceeds any one of several predetermined thresholds for a given short period of time (typically the time period is as small as 15 minutes). The higher the threshold exceeded, the greater the demand charge. Demand charges can become very expensive, sometimes adding up to more than a quarter of an end users total energy and power costs for a typical billing period (e.g. a month or a year).

Alternatively, on-site distributed power generation can be used to reduce an end user's peak power consumption from a local utility and, therefore reduce the demand charges an end user will be subjected to from that local utility. However, distributed power generation is very costly for an end user to purchase and often requires a commitment of a large up-front fee prior to installation. This up-front fee can often discourage or prevent investment in such a distributed power system.

Additionally, a distributed power system typically will not cover the end user's total electric energy requirements. This is because a dedicated distributed power generation system must necessarily follow the electric load (or electric energy consumption requirements) of the end user it is servicing. That user load can vary drastically from a peak load period during peak operating hours to low load, or even no load, during off-peak hours. Such peak load periods may last for only a short percentage of time the distributed power system is operating yet may be as much as twice the average power consumed. All generators operate at maximum efficiency when operating at maximum capacity. Accordingly, if a distributed power generation system is sized to meet peak load requirements of a user, it will be operating at maximum efficiency for only a small percentage of time (e.g., 5 to 10 percent), and operating at a much lower and costlier efficiency when servicing the average load. In other words, the distributed power system will be oversized and will be operating in an unacceptably low capacity and low efficiency mode for most of the time.

To prevent over-sizing, a distributed power system is generally sized to have a maximum capacity that is less than the maximum load requirements of the end user and closer to the average operating load of the user. As a result, even with a distributed power system installed, the user must still depend on remotely located electric suppliers and the local utilities to supply a significant portion, if not most, of its electrical energy requirements.

Yet another problem associated with distributed power systems is that they typically cannot provide back-up emergency generator power for an end user's total energy requirements during a power outage on the grid. Because a distributed power system is generally sized for substantially less than the peak power requirements of an end user, the system can only provide partial back-up emergency power for a user during a grid power outage. This lack of emergency back-up power can be critical for many users, such as hospitals where patient care may be compromised or food distributorships where food may spoil if power is not fully available. As a result, many end users must make an additional and costly investment in a separate and dedicated back-up generator system to supplement the output of the distributed power system during a grid power outage.

Accordingly, there is a need for a system, method and business method for providing electric power and energy to an end user, which can avoid or reduce costs associated with congestion and losses incurred during transmission of energy from an electric supplier and/or local utility. Additionally, there is a need to reduce peak power demand charges incurred from the local utilities. Additionally, there is a need for such a system and method to meet the end user's total electrical energy requirements while operating at or near maximum efficiency regardless of how the end user's load varies. There is also a need for the system, method and business method to be able to provide back-up emergency power to service the entire energy requirements of a user during periods of power outages on the grid. Moreover, there is a need to reduce the burden of a large up-front fee associated with the installation of such a system.

### BRIEF DESCRIPTION OF THE DRAWINGS

The invention will be more fully understood from the following detailed description taken in conjunction with the accompanying drawings, in which:

FIG. 1 is a schematic view of an exemplary embodiment of a power generation system, which includes an electric generator system, for providing electric power and energy to a host in accordance with the present invention;

FIG. 2 is a logic diagram of an exemplary embodiment of a method and business method utilizing the power generation system of FIG. 1 in accordance with the present invention;

FIG. 3 is a schematic view of the electric generator system of FIG. 1 wherein the electric generator system includes a reciprocating natural gas generator; and

FIG. 4 is a schematic view the electric generator system of FIG. 1, wherein the electric generator system includes a compressed air energy storage system with a split-cycle expander generator.

### DETAILED DESCRIPTION

Certain exemplary embodiments will now be described to provide an overall understanding of the principles of the structure, function, manufacture, and use of the methods, business method, systems, and devices disclosed herein. One or more examples of these embodiments are illustrated in the accompanying drawings. Those skilled in the art will understand that the methods, business method, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

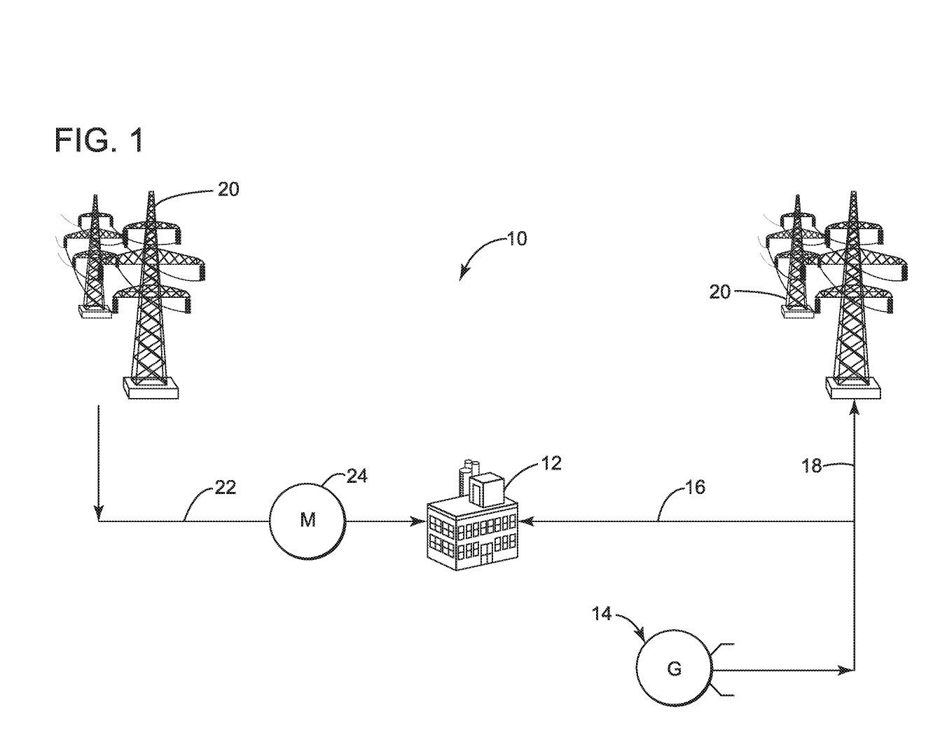

FIGS. 1-4 illustrate various exemplary embodiments of power generation systems 10 and methods 30 for a provider to provide electric energy and power to a host's facility 12, which consumes electric power and energy, in accordance with the present invention.

Referring to FIG. 1, the power generation system 10 includes an electric generator system 14 controlled by a provider, which has an output connected to at least first 16 and second 18 conductive path for servicing the total energy requirements of the host's facility (or host) 12. The first conductive path 16 connects the output of generator system 14 to the host's facility 12 (most likely at the main electric power panel (not shown) of the host's facility) to provide distributed power directly to the host 12 without going through the grid. The second conductive path 18 connects the output of generator system 14 to the grid 20 (most likely at a local utility's substation (not shown) or other local grid distribution facility controlled by the utility) to provide at least electric supplier generated power and energy to the host 12 though the grid 20. The host 12 will consume energy from the grid 20 through grid distribution facilities controlled by a local utility. The local utility will distribute that energy to the host 12 though conductive path 22. Conductive path 22 will connect in series to the host's meter system 24 and to the host 12 as an end user for the local utility. The meter system 24 of host 12 will be utilized by the local utility to measure the power and energy consumed by the host from the grid 20 and, therefore, to determine the fees that the local utility will charge the host 12.

The generator system 14 can include anyone of, or combination of, a number of power generation technologies. For example, the generator system 14 may include natural gas or diesel turbine generators, which have rated power outputs that can reach well over 10 megawatts. The system 14 may also include reciprocating natural gas generators of a type similar to a General Electric Jenbacher part number JMS 624, which has an output rated at approximately 4.3 megawatts. Renewable power generation technologies may be used such as wind, solar or hydro power generators. The generator system 14 may also include a number of split-cycle engine technologies such as the type described in U.S. Pat. No. 6,952,923 filed on Jun. 9, 2004 and U.S. Pat. No. 8,677,953 filed on Mar. 14, 2011, both of which are herein incorporated by reference in their entirety. The generator system may also include a number of compressed air energy storage technologies such as the type described in U.S. patent application Ser. No. 14/543,223 filed on Nov. 17, 2014 and U.S. provisional patent No. 62/120,770 filed on Feb. 25, 2015, both of which are herein incorporated by reference in their entirety.

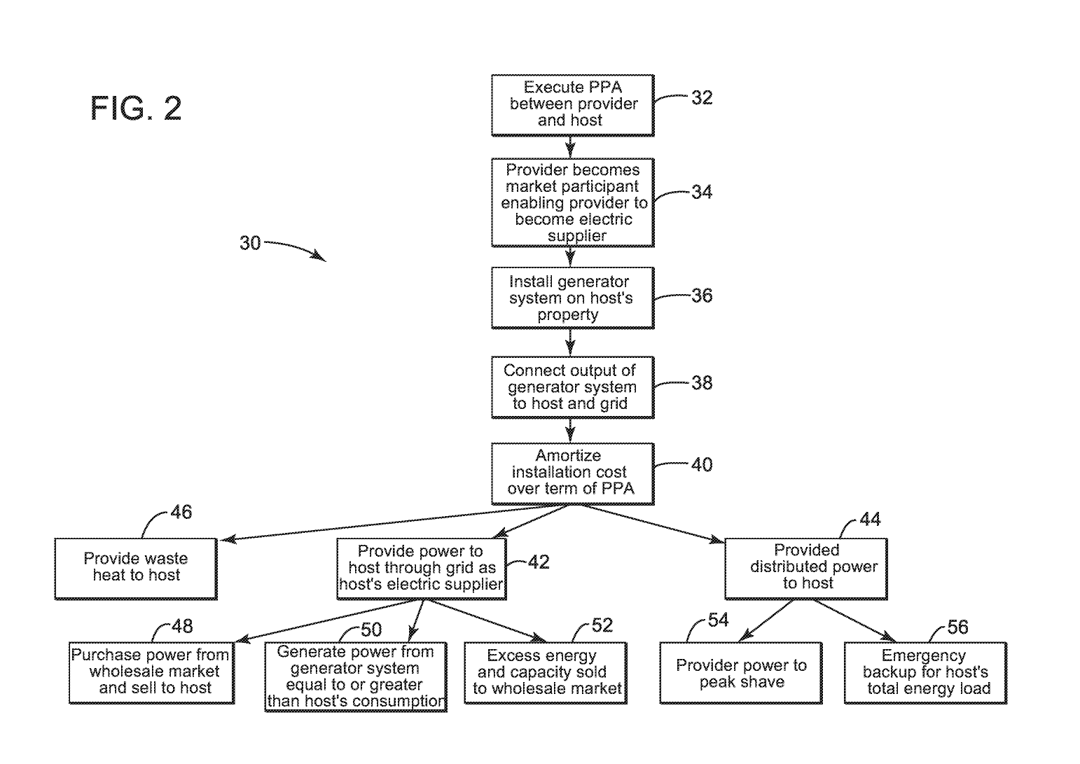

Referring to FIG. 2, an exemplary embodiment of a logic diagram for implementing a method and business method 30 for utilizing the above described system of FIG. 1 to enable a provider to provide power and energy to a host's facility is illustrated. Method 30 includes all, or some, of the following steps:

Step 32 The provider and host execute a power purchase agreement (the PPA) wherein the host agrees to permit the provider to at least install and operate the generator system 14 on the property where the host's facility 12 is located. The host's facility has a load which consumes power and energy.

Step 34 The provider becomes a market participant in the wholesale electricity markets for the region in which the host's property is located. That is, the participant, as a market participant, must successfully complete a membership process with the administrator of the regional wholesale electricity markets, such as an ISO, RTO or similar, and sign an agreement with the administrator, typically known as a market participant service agreement, which details the qualifications, responsibilities and obligations required for participating in the wholesale electricity markets. Becoming a market participant is a necessary requirement to enable the provider to function as the host's electric supplier.

Step 36 The provider installs the generator system 14 on the host's property. Among other tasks, the installation process generally includes the provider executing a generator interconnection agreement with the local utility. The interconnection agreement details the qualifications, responsibilities and obligations required to connect the provider's electric generator system 14 to the utility's grid distribution facilities.

Step 38 The provider connects the output of the generator system 14 to two parallel conductive paths 16 and 18. The first conductive path 16 operatively conducts power and energy to the host's facility 12 without going through the grid 20. The second conductive path 18 operatively conducts power and energy to the grid 20.

Step 40 The provider may optionally amortize all or part of the cost associated with installing the generator system 14 over the period of time that the PPA is in effect (i.e., the term of the PPA). Preferably, the term of the PPA will be long enough such that the up-front fee will be greatly reduced or eliminated. More preferably, the term of the PPA shall be 10 years or more and most preferably the term of the PPA shall be 15 years or more. By entering into a long-term PPA with the host, the costs associated with the installation of electric generator system 14 can be amortized over the term of the PPA, therefore reducing or eliminating any up-front fees associated with those costs.

Step 42 The provider provides power and energy to the host's facility 12 through a local utility as an electric supplier active in the wholesale electricity markets. With the provider functioning as the host's electric supplier, costs associated with congestion and losses inherent in the regional grid transmission system are greatly reduced by installing generator system 14 on the same property that the host's facility 12 is located on. In other words, the close proximity of the host's facility 12 and the electric supplier's generator system 14 will reduce transmission congestion and losses and enable the provider to deliver power to the host for less cost than a remotely located electric supplier having the same generator system 14.

Step 44 The provider provides distributed power and energy to the host's facility 12 through the first conductive path 16 without going through the grid.

Step 46 The provider may optionally provide waste heat generated from the generator system 14 to the host's facility 12.

As illustrated in FIG. 2, the step 42 of the provider providing power and energy to the host's facility as an electric supplier can be divided into at least the following three functional steps:

Step 48 As the electric supplier, the provider may purchase power and energy from the wholesale electricity markets and sell such power and energy to the host through a local utility when it is economically advantageous to do so. The local utility will deliver the power and energy to the host's facility 12 via conductive path 22. For example, this could be particularly advantageous during grid off-peak hours when the price of selling energy to the regional wholesale electricity markets may be too low to profitably run generator system 14. Under that circumstance, the provider may simply elect to turn generator system 14 off and purchase low cost power directly from the wholesale electricity markets to service the energy requirements of the host's facility 12. Additionally, purchasing from the wholesale electricity markets could be done when the generator system must be turned off for normal maintenance functions or during unplanned outages of the generator system 14.

Additionally under step 48, the electric supplier may purchase power and energy from the wholesale electricity markets and sell such power and energy to the host prior to completing the installation of the generator system 14, i.e., prior to completing step 36. The benefit to the provider is that a revenue stream for the sale of electric power and energy would be established before installation is completed. The benefit to the host is that the host would be receiving power and energy from the provider before installation is completed.

Step 50 The provider can also generate power and energy from the generator system 14 to the grid 20 through the second conductive path 18 that is equal to or greater than the facility's consumption of power and energy from the local utility. At least matching the power and energy consumed from the local utility by the host's facility 12 would be one of the normal operating functions of a typical electric supplier.

Step 52 Also, as the electric supplier, the provider can sell power and energy generated from the generator system that exceeds the power and energy consumption of the facility to the wholesale electricity markets. Under the PPA, the provider and host may also agree that the provider can supply more energy to the grid than is required to service the host. For example, the host and provider may agree that generator system 14 be sized to have a capacity that is significantly greater than the energy requirements of the host's facility.

Additionally under step 52, the host and provider may agree that as much energy, capacity and other resources generated by generator system 14 during the term of the PPA as is reasonably practical shall be sold to the wholesale electricity markets. This would be a benefit to the host 12, since it would enable the provider to utilize the grid as a regulator to keep the output of generator system 14 at or near full load and optimum efficiency operating conditions even when the host's facility 12 is operating at low load conditions. Since the generator system 14 would be operating at relatively constant, optimum efficiency conditions, the cost savings of delivering energy to the host 12 would be significant. Moreover, an additional benefit to the host 12 would be that additional capacity from generator system 14 would be available to handle significant future growth of the host's facility 12.

As additionally illustrated in FIG. 2, the step 44 of the provider providing distributed power and energy to the host's facility 12 through the first conductive path 16 without going through the grid can be divided into at least the following two functional steps:

Step 54 The provider may provide power and energy to the facility 12 to peak shave the power and energy consumption from the local utility by the facility 12. Ordinarily, even though the provider is functioning as the electric supplier on the property of the host's facility 12 (as illustrated in step 42), the power delivered through a local utility will, nonetheless, be subject to significant demand charges that will increase as the peak power consumption of the host user increases. However, on-site distributed power generation can be used to reduce an end user's peak power consumption from a local utility and, therefore reduce the demand charges an end user will be subjected to from that local utility.

Step 56 The provider can also provide emergency back-up distributed power and energy to the facility 12 during a power outage at the local utility. Significantly, since generator system 14 would have a capacity which exceeds the host's energy requirements (as discussed in step 52), the system 14 could provide full emergency back-up. This would be advantageous over traditional prior art distributed power systems, which are necessarily sized for a capacity that is less than the host's total energy needs and can only provide partial emergency back-up power during a grid power outage. This would also eliminate the need to purchase a supplemental emergency back-up generator to augment the output of a prior art distributed power system during such a power outage.

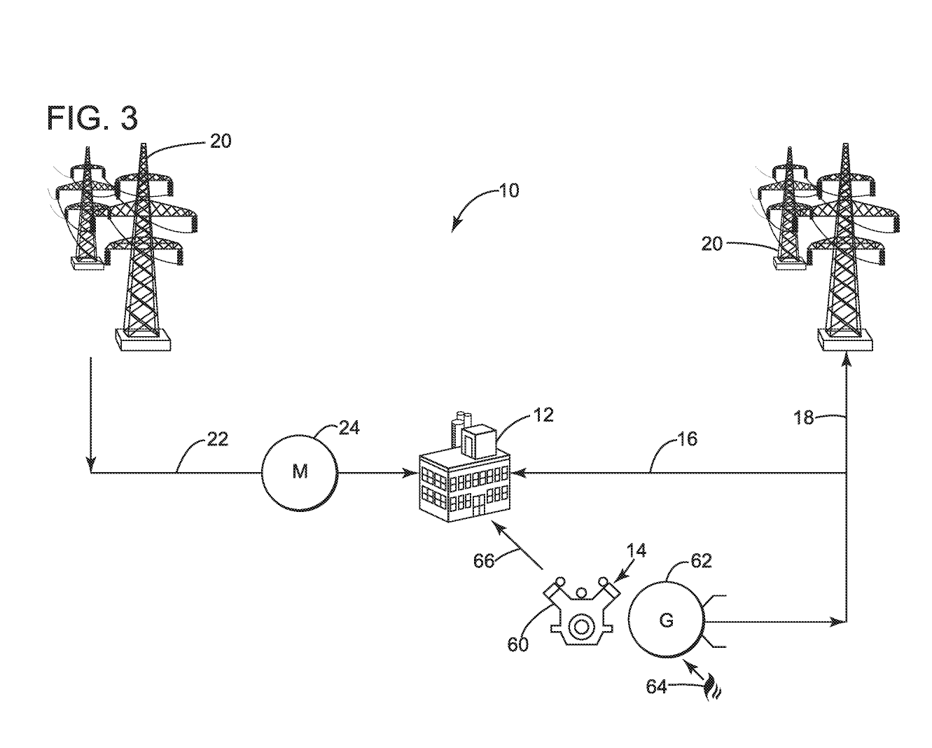

Referring to FIG. 3, as discussed earlier herein, the generator system 14 of power generation system 10 may include any appropriate electric generation system and electric generation technology. However, in the size range of ten megawatts or less, it is preferable that generator system 14 include a reciprocating engine 60 operatively coupled to an electric generator 62. This is especially the case with natural gas 64 reciprocating engine generators, such as the type produced by the Jenbacher division of General Electric. Alternatively, the reciprocating engine 60 may be a split-cycle engine as defined herein, for potentially enhanced efficiency. Additionally, in this FIG. 3 embodiment, waste heat 66 from the reciprocating engine 60 is being captured and used to heat the facility 12.

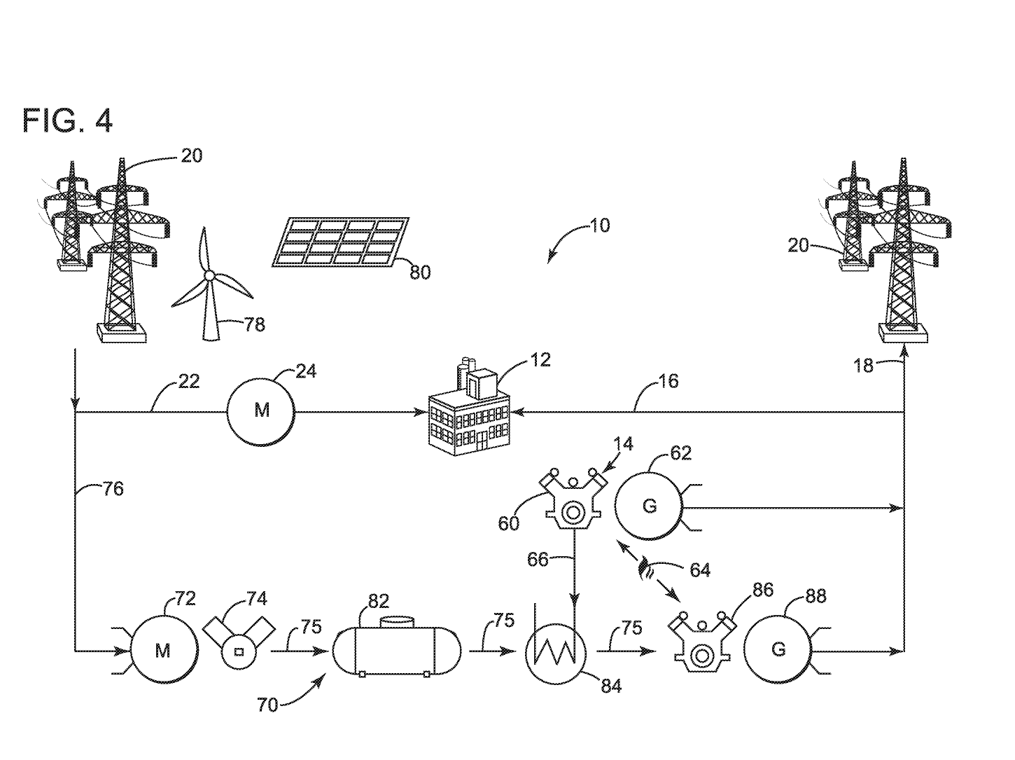

Referring to FIG. 4, in this exemplary embodiment the generator system 14 further includes a compressed air energy storage (CAES) system 70 to enhance the output efficiency and capacity of the generator system 14. CAES system 70 includes an electric motor 72 coupled to and driving a compressor 74. The motor can be powered by energy from the grid 20 through a conductive path 76, but may also be powered by renewable energy resources such as wind 78 or solar 80.

The compressed air 75 from compressor 74 is stored in an air tank storage system 82 to be used at a later time. The capacity and size of the air tank storage system 82 will vary depending on how much energy the system is required to store.

When the compressed air energy in the air tank storage system 82 is needed, or when it is economically advantageous to use such energy, the compressed air 75 is released from the storage system 82, directed through heat exchanger 84 and into a split-cycle expander 86. In this embodiment, the waste heat 66 from reciprocating engine 60 is used to add heat energy to the compressed air as it passes through heat exchanger 84. When the energy of the waste heat 66 from engine 60 is combined with energy of the compressed air from air storage tank system 82, the efficiency of the split-cycle expander can increase by as much as 15% or more. The heated compressed air 75 is mixed with natural gas 64 in the combustion chambers (not shown) of split-cycle expander 86 to combust and power the expander. Expander 86 is operatively coupled to a generator 88, which is driven by expander 86 to generate the output of the CAES system 70. The output of the CAES system 70 is combined with the output of generator 62 to provide additional power and energy to the host and grid along conductive paths 16 and 18 respectively.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

1. A method of a provider providing electric power and energy to a host, comprising the steps of the provider:
executing a power purchase agreement (PPA) between the provider having an electric generator system for generating power and energy and the host having a facility which consumes electric power and energy, the facility located on a property of the host;
becoming a market participant in the wholesale electricity markets within a region that the host's property is located;
installing the generator system on the property of the host;
connecting an output of the generator system to first and second conductive paths, the first conductive path operatively conducting power and energy to the host's facility without going through the grid, the second conductive path operatively conducting power and energy to the grid;
providing distributed power and energy to the host's facility through the first conductive path without going through the grid; and
providing power and energy to the host's facility as an electric supplier active in the wholesale electricity markets.

2. The method of claim 1 wherein the step of the provider providing power and energy to the host's facility as an electric supplier comprises one of:
purchasing power and energy from the wholesale electricity markets and selling such power and energy to the host through a local utility;
generating power and energy from the generator system to the grid through the second conductive path that is equal to or greater than the facility's consumption of power and energy from the local utility; and
selling power and energy generated from the generator system that exceeds the power and energy consumption of the facility to the wholesale electricity markets.

3. The method of claim 1 wherein the step of the provider providing distributed power and energy to the host's facility comprises one of:
providing power and energy to the facility to peak shave the power and energy consumption of the facility; and
providing emergency back-up power and energy to the facility during a power outage at the local utility, wherein such emergency back-up power and energy meets the facility's total consumption requirements of power and energy.

4. The method of claim 1 comprising the step of the provider providing waste heat generated from the generator system to the facility of the host.

5. The method of claim 1 wherein the step of becoming a market participant comprises executing a market participant service agreement with a regional administrator of the wholesale electricity markets, which details the qualifications, responsibilities and obligations required for participating in the wholesale electricity markets.

6. The method of claim 1 wherein the step of the provider installing the generator system comprises executing a generator interconnection agreement with a local utility.

7. The method of claim 1 comprising the step of the provider amortizing a cost of installing the generator system over a term of the PPA.

8. The method of claim 7 wherein the term of the PPA is at least 10 years.

9. The method of claim 7 wherein the term of the PPA is at least 15 years.

10. The method of claim 1 wherein the host has one of an ownership interest in the property and a leasehold interest in the property.

11. The method of claim 1 wherein the generator system includes a split-cycle engine.

12. The method of claim 1 wherein the generator system includes a reciprocating engine.

13. The method of claim 1 comprising the step of installing a compressed air energy storage (CAES) system to supplement the output of the generator system.

14. The method of claim 13 wherein the CAES system includes a split-cycle expander.

15. The method of claim 1 wherein the step of the provider providing power and energy to the host's facility as an electric supplier comprises purchasing power and energy from the wholesale electricity markets and selling such power and energy to the host through a local utility prior to installing the generator system on the property of the host.
